(19) United States
(12) Patent Application Publication
(10) Pub. No.: US 2026/0344679 A1
(43) Pub. Date: Nov. 5, 2026

(54) BOTANICAL INSECTICIDE AND FUNGICIDE FORMULATIONS AND METHODS OF PREPARATION

(71) Applicants: Marcus Kraig Stone, Tarn-et-Garonne (FR); Quassia Labs Ltd., St Helier (JE)

(72) Inventors: Leonardo Solorzano, Kitchener (CA); Martha Liliana Rodriguez, Kitchener (CA); Byron José Flores Somarriba, León (NI); Christiane Düttmann, León (NI); María Camila Gutiérrez Buitrago, Bogotá (CO); Perluigi Caboni, Monserrato (IT); Francesco Corrias, Monserrato (IT)

(21) Appl. No.: 19/489,134

(22) PCT Filed: May 3, 2024
(86) PCT No.: PCT/IB2024/054280

§ 371 Date: Dec. 1, 2025

Related U.S. Application Data
(60) Provisional application No. 63/463,753, filed on May 3, 2023.

(51) Int. Cl. A01N 65/34; A01N 63/20; A01P 5/00; A01P 7/04

(52) U.S. Cl. CPC A01N 65/34; A01N 63/20; A01P 5/00; A01P 7/04

(57) ABSTRACT

Botanical insecticide, nematicide, miticide, and fungicide formulations and methods of preparation are described. An insecticidal composition containing Quassia amara extract demonstrated insecticidal effect in several target pests, making it suitable to use in an integrated pest management scheme. The Quassia amara extract may be particularly useful in combatting Frankliniella occidentalis, Trialeurodes vaporariorum, and Tetranychus urticae for which Quassia amara insecticidal activity has not been previously reported. The Quassia amara also displayed nematocidal activity against Meloidogyne. A combined insecticidal and nematocidal composition containing Quassia amara is provided for application to crops.

### TECHNICAL FIELD

The embodiments disclosed herein relate to insecticides and fungicides, and, in particular to botanical-derived bioinsecticide and biofungicide formulations and methods of preparation.

### INTRODUCTION

The Quassia amara plant is part of the Simaroubaceae family, including 32 genera and more than 170 species (Alves, I. A. B. S., et al., Revista Brasileira de Farmacognosia, 2014, vol. 24(4), 481-501). Many genera of this family produce a wide range of substances including quassinoids, alkaloids, triterpenes, steroids, coumarins, anthraquinones, flavonoids, essential oils, and other metabolites (Barbosa, L. F., et al., Chemistry and Biodiversity, 2011, vol. 8(12), 2163-2178). These metabolites have a wide range of applications, including antimalarial, cosmetic, digestive, and pest control. (Barbosa et al.; Gonzalez, M. G. et al., 1996, Rev Biol Trop, vol. 44 (3), 47-50). Many of these uses are reported in Latin America and come from traditional knowledge of the local communities (Alves et al.).

The potential use of Quassia amara as an insecticide can be found as far back as 1884 (Saez, J. A. L. & Soto, J. P., Bol Latinoam Caribe Plantas Med Aromat, 2008, vol. 7 (5), 234-246). Table 1 (Alves et al.), shows different compounds reported in the Quassia genus, and their localization in the plant. The high number of active compounds in the Quassia amara species has several benefits from an insecticide product development standpoint, such as unlikely development of resistance by a host, and supports the use of a plant extract rather that a purified substance for integrated pest management in crop rotations.

TABLE 1
Compounds reported in Quassia amara.

| Compound | Plant Site |
|---|---|
| Simalikalcatone D, E | Leaves |
| Quassin | Leaves, bark and wood |
| Neoquassin | Leaves, bark and wood |
| Picrasins B, H, I, J, K | Leaves |
| Parasin | Stem |
| Quassimarin | Bark |
| Chaparrinone | Aerial Parts |
| Samaderins B, E, X, Y, Z | Stem |
| Simarinolide | Stem |
| Indaquassins A, B, C, D, E, F | Stem |
| Brucein D | Stem |
| Soulameolide | Stem |

Quassin and neoquassin are triterpenes that have been reported for their insecticidal activity (Gonzalez, et al.). It has been suggested that quassin has an inhibitory effect on the tyrosine activity in mosquito larvae, interfering with melanin synthesis and impeding cuticle hardening (Evans, D. A. & Raj, R. R., Indian journal of biochemistry & Biophyhsics, 1992, vol. 29(4), 360-363; Evans, D. A. & Raj, R. R, Indian Journal of Medical Research—Section A Infectious Diseases, 1991, vol. 93, 324-327). Affected individuals cannot properly molt, or repair damage to the cuticle and are more susceptible to other insecticides (Sterkel, S. M., et al., Insect Biochem Mol Biol, 2019, vol. 108, 24-31).

Table 2 summarizes other studies reporting Quassia amara insecticide activity against aphids (Homoptera), lepidoptera, coleoptera, hemiptera, hymenoptera, thysanoptera and mite species.

TABLE 2
Quassia amara insecticide activity.

| Scientific Name | Common name | Reference |
|---|---|---|
| Culex quinquefasciatus | Mosquito larvae | Evans, D. A. & Raj, R. R, Indian |
| | | Journal of Medical Research - |
| | | Section A Infectious Diseases, 1991, |
| | | vol. 93, 324-327 |
| Species not specified | Whitefly | Kleeberg, H., Journal of Cultivated |
| | | Plants, 2010, vol. 62(3), 75-80 |
| Bemisia tabaci | Whitefly | Flores, G., Rev Biol Trop, 2008, vol. |
| | | 56(4), 2131-2146 |
| Periplaneta americana | American cockroach | Park, M. H., et al., Chem Pharm Bull |
| | | (Tokyo), 1987, vol. 35 (7), 3082-3085 |
| Plutella xylostella | Diamondback moth | Dialo, M., et al. Biosci Biotechnol |
| | | Biochem, 1993, vol. 57(2), 244-246 |
| Plutella xylostella | Diamondback moth | Jababu, J. et al., Acta Horticulturae, |
| | | 2019, vol. 1242, 941-948 |
| Helicoverpa armiguera | Earworm | Calin, M., Acta Hortic, 2020, vol. |
| | | 1269, 161-1698 |
| Melodogyne sp. | Meloidogyne | Salazar-Anton, W. & Hernandez- |
| | nematode | Guzman, T de J., Agronomia |
| | | Mesoamericana, 2022, vol. 25(1), |
| | | 111-119 |
| Myzus persicae | Green patch aphid | Navas, H. R. & Blanco, F. A., |
| | | Uniciencia, 2022, vol. 9(1), 51-55 |
| Epilachna varivestis | Mexican bean beetle | Leskinen, V. et al., J. Chem Ecol, |
| Spodoptera eridiana | Southern armyworm | 1984, vol. 10(10), 1497-1507 |
| Hoplocampa | Apple sawfly | Psota, V. et al., Horticultural Science, |
| testudinea | | 2010, vol. 37, 139-144 |

The Piperaceae (Piper) family, also known as pepper plants, are primitive Angiosperms and comprises more than 3500 species in tropical and subtropical regions with origins in Peninsular Malaysia (Cardenas-Laverde, D., et al., Natural Product Communications, 2022, vol. 17(4): 1934578X221089995). The presence of oil in the cells classifies them as aromatic plants. In general, Piper species have many active compounds, including amides, flavonoids, prenylated benzoic acid derivatives, lignans, phenylpropanoids, butenolides, and cyclopentenediones which were isolated and classified from 22 Piper species (Xu, W. H & Li, X. C., Current Bioactive Compounds, 2011, vol. 7(4), 262-267).

Piper tuberculatum, a wild relative of the common pepper (Piper nigrum), produces principally amides (Piperamides) as secondary metabolites with insecticidal, antifungal and trypanocide activity. In addition, P. tuberculatum has antiproliferative, anticancer, (Bezerra et al., 2015) and antiparasitic effects (De Souza et al., 2018, Dos Santos Sales, et al., 2018). FIG. 1, shown amides with antifungal activity biosynthesized by P. tuberculatum: piperine (1); piperlonguminine (2); fagaramide (3); (E)-piplartine (4); and pellitorine (5) (Cotinguiba, F., et al., Brazilian Journal of Biology, 2017, vol. 78, 117-124). Other piperamides biosynthesized by P. tuberculatum include: 4,5-dihydropiperine, (5), 4,5-dihydropiperlonguminine, trans-piplartine, cis-piplartine, and dihydropiplartine (Cotinguiba, F., et al, Brazilian Journal of Biology, 2023, vol. 82).

Table 3 summarizes studies reporting insecticidal activity of P. tuberculatum extracts.

TABLE 3
Piper tuberculatum insecticide activity.

| Scientific Name | Common name | Reference |
|---|---|---|
| Aedes | Rockpool | Scott, I. M., et al., Agriculture and Forest |
| atropalpus | mosquito | Entomology, 2002, vol. 4(2), 137-144 |
| Anopheles | American malaria | Trinidade, F. T. T., et al., Rev Braz Farm, |
| darlingi | mosquito | 2012, vol. 22, 979-984 |
| Stomoxys | Stable fly | Lacerda, C. L. Avaliação do potencial |
| calcitrans | | inseticida de extratos de Piper tuberculatum |
| | | contra a mosca-dos-estábulos Stomoxys |
| | | calcitrans. 2017. Dissertação (Mestrado em |
| | | Ciências Ambientais) - Universidade Federal |
| | | de Rondônia, Rolim de Moura, 2017. |
| Diatrea | Sugar cane borer | Debonsi, H. M., et al., Pest Managemnet |
| saccharalis | | Science, 2009, vol. 65(1), 47-51 |
| Anticarsia | Velvet bean | Navickiene, H. M. D., et al., Pest |
| gemmates | caterpillar | Management Science, 2007, vol. 63(4), 399- |
| | | 403 |
| Ostrinia | European corn | Gbewonyo, W. S. K. & Candy, D. J., J |
| nubilalis | borer | Chromatography, 1992, vol. 63, 105-111; |
| | | Bernard, C. B., et al., J Chem Ecol, 1995, vol. |
| | | 21, 801-814; Scott, I. M., et al., Journal of |
| | | Economic Entomology, 2004, vol. 97(4), |
| | | 1390-1403 |
| Spodoptera | Fall armyworm | CASTRO, M. J. P.; SILVA, P. H. S.; PÁDUA, |
| frugiperda | moth | L. E. M. Potencial de Piper tuberculatum |
| | | Jacq. (Piperaceae) no desenvolvimento da |
| | | lagarta-do-cartucho-do-milho. Magistra, v. |
| | | 22, n.2, p. 88-95, 2010 .; Tavares, W. S., et |
| | | al., Journal of Medicinal Plants Research, |
| | | 2011, vol. 5(21), 5301-5306; Castral, T. C., et |
| | | al., J Agric Food Chem, 2011, vol. 59, 4822- |
| | | 4827; Risco, G. V., et al., Revista |
| | | Colombiana de Entomologia, 2012, vol. |
| | | 38(1), 35-41 |
| Zabrotes | Mexican bean | Da Silva K. F., Baldin E. L. L., Pannuti L. E. R. |
| subfascial | weevil | Use of botanical insecticides as an alternative |
| | | for the management of the mexican bean |
| | | weevil [Inseticidas vegetais como alternativa |
| | | para o manejo do caruncho-do-feijão], |
| | | 2016, Revista Caatinga, 29 (2), 348-357 |
| | | DOI: 10.1590/1983-21252016v29n211rc |
| Hypothenemus | Coffee bean borer | Soares, W. P., et al., Revista em Agrónegocio |
| hampei | | e Meio Ambiente, 2022, vol. 15(1), 19-29. |
| Apis mellifera | Western honey | Miranda, J., et al., Apidologie, 2003, vol. |
| | bee | 34(4), 409-415 |

P. tuberculatum amines have also demonstrated potent anti-fungal activity when measured by mycelial growth inhibition (MGI). Table 4 summarizes studies reporting anti-fungal activity of P. tuberculatum extracts.

TABLE 4
Piper tuberculatum anti-fungal activity.

| Phytopathogenic | |
|---|---|
| Fungi | Reference |
| Cladosporium | Alécio, A. C., et al., J Nat Prod, 1998, vol. 61, |
| sphaerospermum | 637-639; Navickiene, H. D. M, et al., |
| Cladosporium | Phytochemistry, 2000, vol. 55, 621-626; da Silva, |
| cladosporioides | R. V. et al., Phytochemistry, 2002, vol. 59, 621-627 |
| Rhizoctonia solani | Sousa, I., et al., Revista Ibero-Americana de |
| Sclerotium rolfsii | Ciências Ambientais, 2018, vol. 9(3), 50-56. |
| Fusarium | Fernandez, M. D. et al., Revista mexicana de |
| oxysporum | fitopatología, 2021, vol. 39(1), 198-206; Cardenas- |
| | Laverde, D., et al., Natural Product |
| | Communications, 2022, vol. 17(4): |
| | 1934578X221089995 |
| Aspergillus niger | Ruiz-Vasquez, L., et al., Plants, 2022, vol. 11(14), |
| Botrytis cinerea | 1793 |
| Alternaria alternate | |

The Fusarium genus is a plant pathogen of the utmost importance, affecting maize, wheat, rice, potatoes, tomatoes, beans, sorghum, banana, sugar cane and mangoes (Summerell, B. A., et al., Fungal Divers, 2011, vol. 46, 1-27). Fusarium inhabits the soil for a long time in the form of chlamydospores that penetrate the roots, extend in the tissues, colonize the xylem vessels blocking them and causing yellowing, wilting, and death in plants (Arie, T., J Pestic Sci, 2019, vol. 44(4), 275-281). Once the soil is contaminated it is almost impossible to eradicate, being able to survive underground for more than 20 years without effective control. (Martinez-Solorzano, G. E. et al., Agronomía Mesoamericana, 2020, 259-276). In addition, the control of this phytopathogen fungi is complex, it is resistant to chemical fungicides thiabendazole, and carbendazim (Brent, K. J. & Hollowman, D. W., Fungicide Resistance in Crop Pathogens: How Can It Be Managed? 2nd ed., 2007, FRAC: Brussels).

Root-knot nematodes (Meloidogyne spp) are one of the most damaging parasitic nematodes for field crops (Andres, M. F., et al, Phytochemistry Reviews, 2012, 11(4), 371-390). Synthetic nematicides used to manage nematode yield losses pose undesirable side effects. Essential oils of Mentha piperita (peppermint) were shown to increase the mortality rate of juvenile Meloidogyne indicating nematocidal activity.

Accordingly, there is a need for new insecticidal, fungicidal and nematocidal formulations having diverse metabolites secondaries and synergism to avoid the development of resistance in insects and fungi. New cost-effective methods of preparation for such formulations are also needed.

### SUMMARY

Botanical insecticide and fungicide formulations and methods of preparation are described. The formulations described herein may be effective against several common agricultural pests and may be used as part of an integrated pest management strategy.

According to an embodiment, there is an insecticidal composition. The insecticidal composition may be particularly useful in combating one or more of: Frankliniella occidentalis, Trialeurodes vaporariorum, and Tetranychus urticae.

The insecticidal composition comprises a Quassia amara extract including quassin and neoquassin, a surfactant, an emulsifier, a UV protector, an oil vehicle, and clay. The surfactant and emulsifier are provided to ensure homogenous mixing of the various components. The UV protector is provided to protect against photodegradation of the active compounds. The clay is provided for additional UV protection and to achieve a formulation with less decantation in storage. The insecticidal composition may further include a buffer for maintain the pH of the composition between 3-7.

According to another embodiment, there is a method for preparing a fungicidal composition comprising chitosan and a Piper tuberculatum extract. The method comprises: preparing a chitosan solution, adding acid to the solution, and stirring the solution overnight. The method further includes preparing a Piper tuberculatum extract, adding an oil vehicle to the extract to form an emulsion and adding a surfactant to the emulsion. The method further includes combining 5 parts of the chitosan solution with 1 part of the Piper tuberculatum extract/oil/surfactant to form a mixture, centrifuging the mixture and adjusting the pH of the mixture to between 3-7. According to embodiments where a solid preparation is desired, the method further comprises drying the mixture until solid.

According to an embodiment, there is a combined insecticidal and nematocidal composition. The combined insecticidal and nematocidal composition may be particularly useful in combating one or more of: Frankliniella occidentalis, Trialeurodes vaporariorum, Tetranychus urticae, and Meloidogyne sp.

The combined insecticidal and nematocidal composition comprises a Quassia amara extract including quassin and neoquassin, Leucidal liquid, Hawthorn extract, an oil vehicle (e.g., soybean oil), an emulsifier (e.g., Olivem 1000) and water. The combined insecticidal and nematocidal composition may be further diluted in a volume of water and applied to crops such that an amount of the active ingredients (quassin+neoquassin) from the Quassia amara extract applied to the crops is ~1200 mg/hectare.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is chemical diagrams of antifungal metabolites isolated from Piper tuberculatum;

FIG. 2 is a chart summarizing direct application of Quassia amara extract to agricultural pests, according to an embodiment;

FIGS. 3A and 3B are a chart and a table, respectively, quantifying insecticidal activity of Quassia amara extract on several agricultural pests, according to an embodiment;

FIG. 4 is a chart quantifying insecticidal activity of Quassia amara extract on T. urticae eggs, according to an embodiment;

FIGS. 5A and 5B are a chart and a table, respectively, showing dose-dependent insecticidal activity of Quassia amara extract on Frankliniella occidentalis larvae, according to an embodiment;

FIG. 6 is a table showing insecticidal compositions of Quassia amara extract, according to several embodiments;

FIG. 7 is a chart showing fungicidal activity of Piper tuberculatum extract on Fusarium sp, according to an embodiment;

FIG. 8 is a chart showing fungicidal activity of Piper tuberculatum extract on Rhizoctonia sp, according to an embodiment;

FIG. 9 is a chart showing fungicidal compositions of Piper tuberculatum extract, according to several embodiments;

FIG. 10 is a flow chart of a method for preparing a fungicidal composition, according to an embodiment;

FIG. 11 is a chart showing biological activity of Quassia amara extract on Meloidogyne sp, according to an embodiment;

FIG. 12 is an exemplary micrograph showing Meloidogyne after Quassia amara treatment;

FIGS. 13A-13B are tables showing nematicide compositions of Quassia amara extract, according to several embodiments;

FIG. 14 is a chart showing biological activity of Mentha piperita extract on Meloidogyne, according to an embodiment; and

FIG. 15 is a a chart showing biological activity of a mixture of Mentha piperita and Quassia amara extracts on Meloidogyne, according to an embodiment.

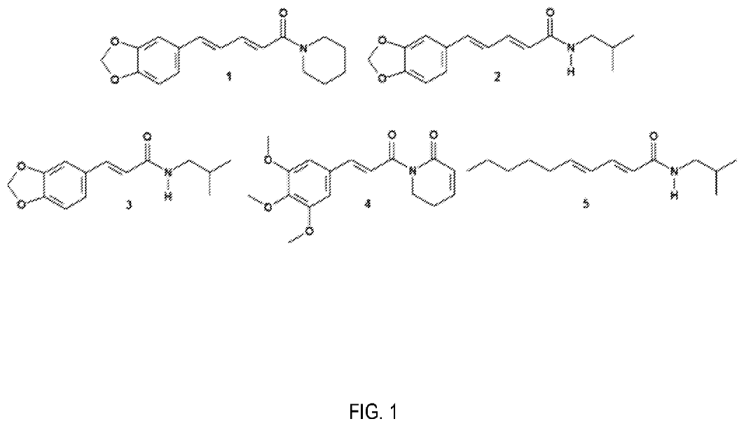

### DETAILED DESCRIPTION

Various formulations, compositions and processes will be described below to provide an example of each claimed embodiment. No embodiment described below limits any claimed embodiment and any claimed embodiment may cover processes or formulations that differ from those described below. The claimed embodiments are not limited to formulations or processes having all of the features of any one formulation or process described below or to features common to multiple or all of the formulations described below.

When a tilde (~) is used herein, it signifies a range of ±10% of the indicated value. For example, ~1.0 means between 0.9 to 1.1.

Quassia amara Bioinsecticide Activity.

The insecticidal activity of Quassia amara extract was tested against agricultural pests including Frankliniella occidentalis (thrips), Trialeurodes vaporariorum (whitefly), Tetranychus urticae (two-spotted mite), Macrosiphium euphorbiae (potato aphid), Plutella xylostella (diamondback moth) and the beneficial predatory mite Phytoseiulus persimilis in eggs, juvenile and adult stages. Biological activity of Quassia amara extract was also tested against juveniles of the phytopathogenic nematode Meloidogyne.

The Quassia extract was prepared by placing 100 g of Quassia amara bark and branches in 500 mL of ethanol (95%) for 36 hours at room temperature and filtering through filter paper (e.g., Whatman® #4). Branches of Quassia amara were cleaned with water and a brush to remove dirt and debris then cut into pieces 1-1.2 inch (2.5-3 cm) in size and split prior to hydroalcoholic extraction.

The raw Quassia extract was further diluted in ethanol to a final concentration of 500 mg/mL before direct application to the agricultural pests.

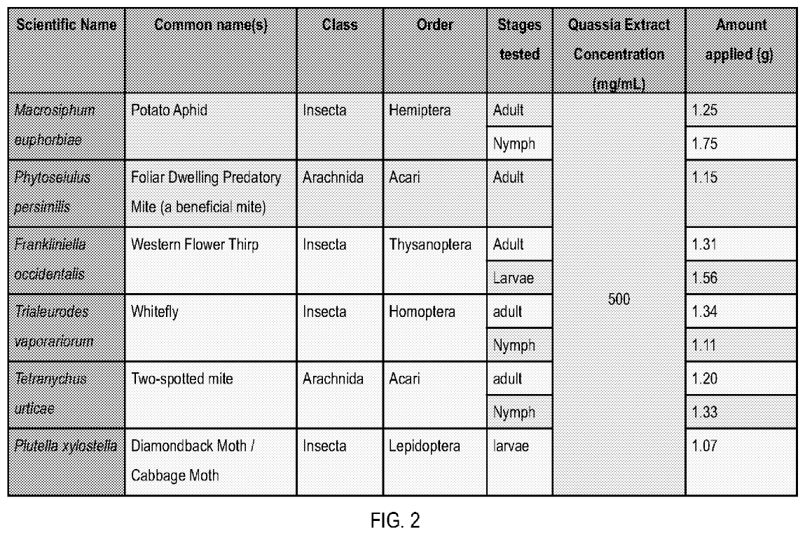

All bioassays were done in 4 cm Petri dishes, with five repetitions per treatment and five individuals per petri dish. The Quassia extract was applied by direct contact with an airbrush in the amounts shown in FIG. 2. Mortality was quantified from day 1 to 10, correcting for the dead individuals in the control.

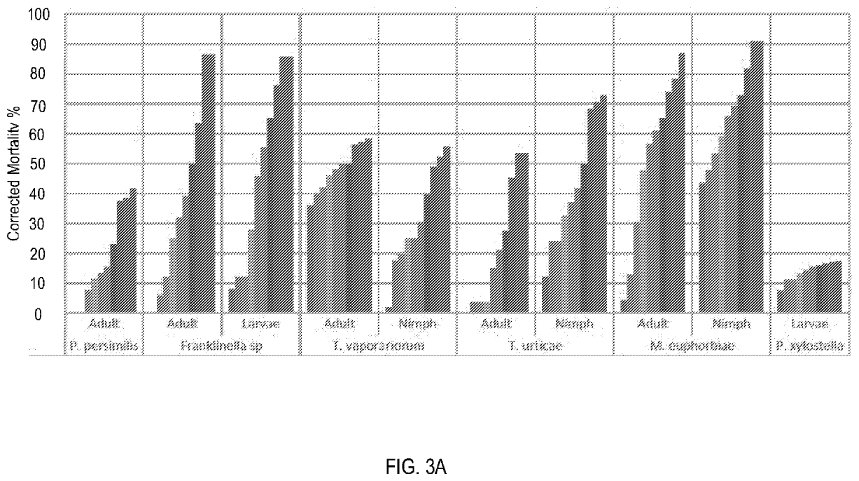

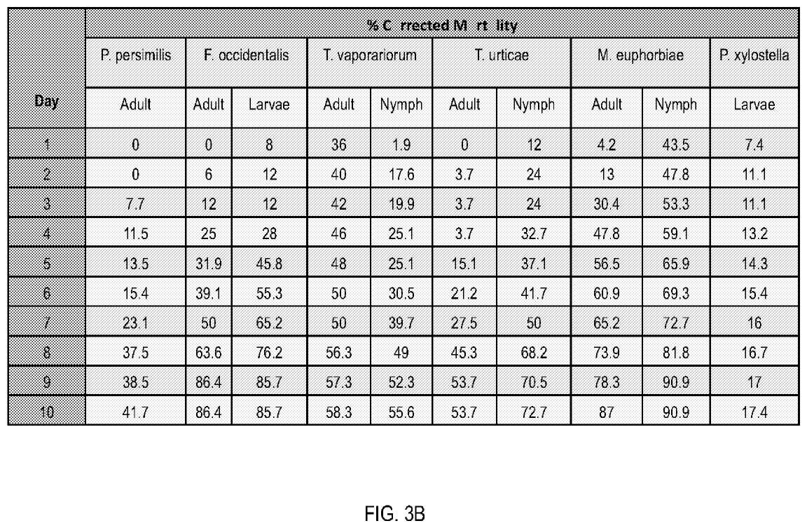

FIGS. 3A and 3B, show the results of the bioassays quantifying the insecticidal activity of Quassia amara extract on agricultural pests, according to an embodiment. The bars in FIG. 3A correspond to the corrected mortality percent observed between day 1 to day 10 of the assay. Quassia extract showed strong insecticidal activity against Franklinella sp, T. urticae and M. euphorbiae, good insecticidal activity in T. vaporariorum and low level of activity in P. xylostella. The insecticidal effect on beneficial mite P. persimilis was generally similar to the effect observed on the two-spotted mite, T. urticae. It is also notable that effective insecticidal control (at least 60% corrected mortality) was achieved around day 10, consistent with a proposed mode of action of an Insect Growth Regulator (IGR). For example, the mode of action may be 1) mite growth inhibitors affecting chitin synthase 1 (CHS1); 2) inhibitors of chitin biosynthesis affecting CHS1; 3) type 1 inhibitors of chitin biosynthesis; or 4) moulting inhibitors (“Mode of Action” Insecticide Resistance Action Committee (IRAC) available at <https://irac-online.org/mode-of-action/>).

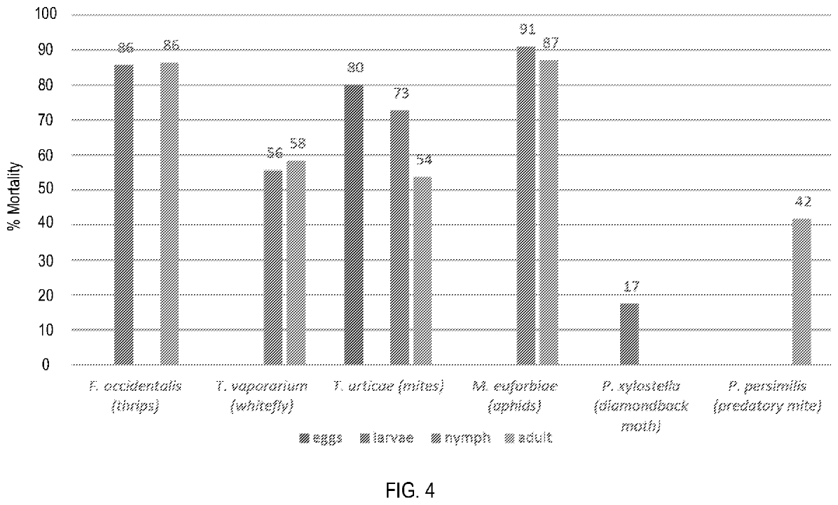

Referring to FIG. 4, shown therein is the insecticidal effect of the Quassia amara extract at a concentration of 500 mg/mL on T. urticae eggs, according to an embodiment. In this case, there was only one evaluation 10 days before the application (1.07 g, direct contact with an airbrush in a Petri dish). The Quassia amara extract showed insecticidal control at an 80% level.

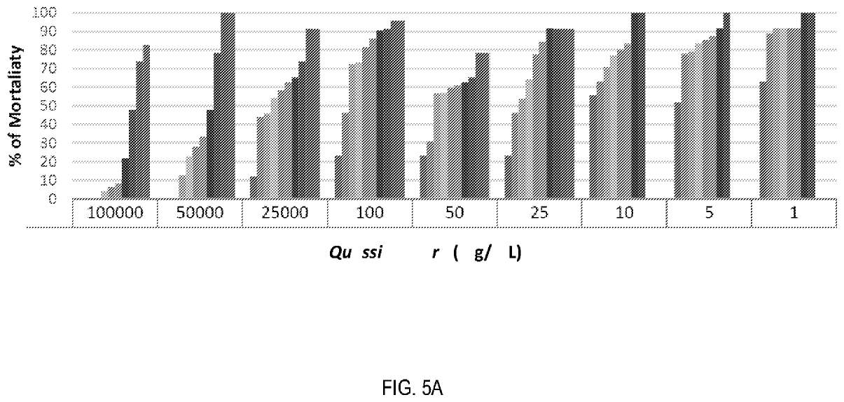

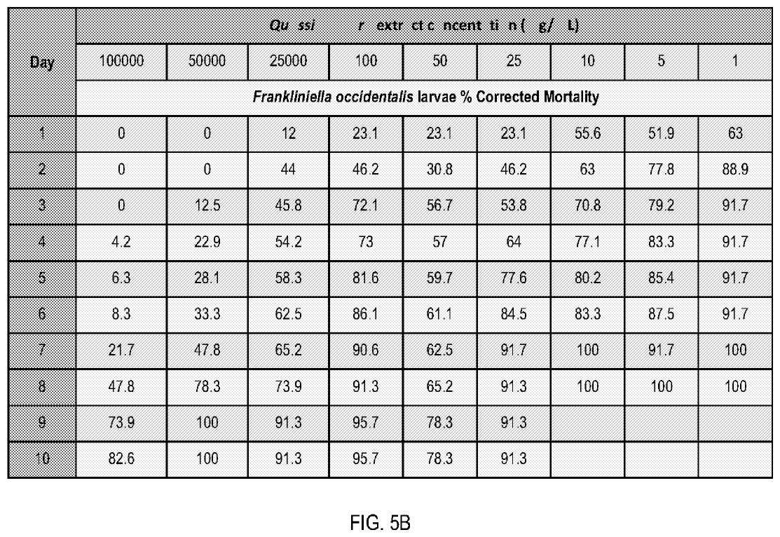

Referring to FIGS. 5A and 5B, shown therein is dose-dependent insecticidal activity of Quassia amara extract on Frankliniella occidentalis larvae, according to an embodiment. The Quassia amara doses were varied between 1 and 100000 mg/mL, looking for a minimum effective dose for acceptable insecticidal control. Interestingly, and counter-intuitively, lower doses of Quassia amara extract generally resulted in higher insecticidal activity. This may be due to the nature of Quassia extract having several active compounds that may operate in synergistic fashion to produce the insecticidal effects observed. Thus, it can be concluded that Quassia extract has potent dose-dependent insecticidal activity in at least Frankliniella occidentalis larvae.

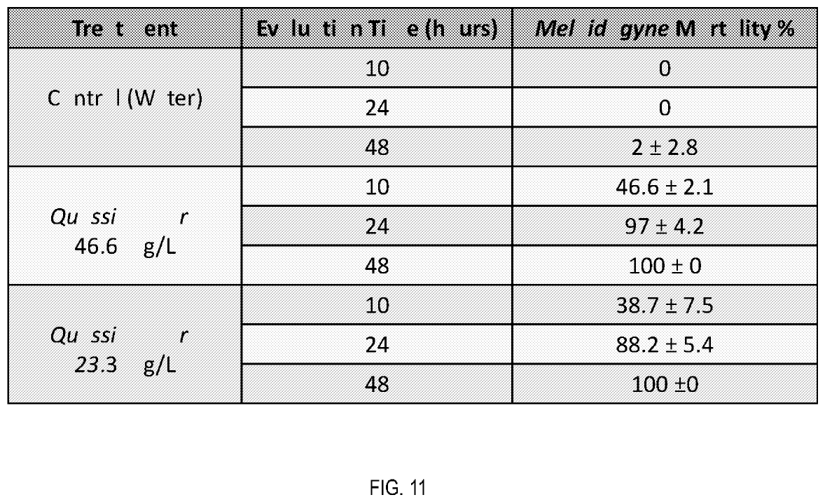

Referring to FIG. 11, shown therein is a chart of nematicide activity of Quassia amara on juvenile Meloidogyne sp, according to an embodiment. A Quassia amara hydroalcoholic extract (prepared as described above). The concentration of quassin and neo-quassin combined in the Quassia extract was 466.51 mg/ml as determined by HPLC-mass spectrometry. Microbiological purity analysis determined that the extract was ~100% pure having negligible amounts of mesophilic aerobic bacteria, fungi, and yeast contaminants. 23.3 mg/L and 46.6 mg/L concentrations of the Quassia extract and a control sample (water) were incubated with Meloidogyne sp and mortality was observed at 10, 24 and 48 hours after application of the Quassia extract. Dead and living nematodes were quantified; those that seemed immobile were stimulated with a fine brush and those that did not move after the stimulus were considered dead.

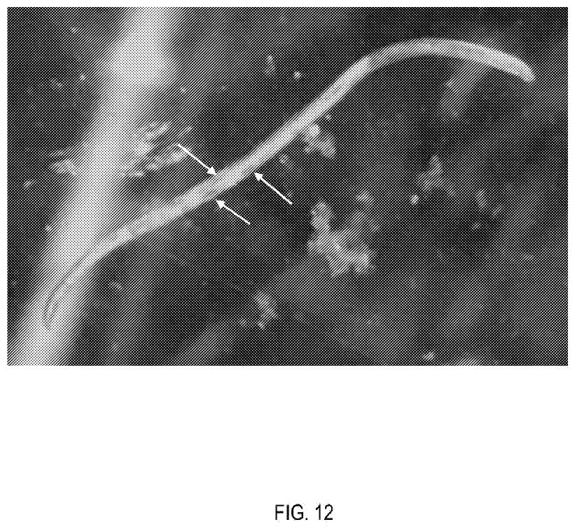

As shown in FIG. 12, some following treatment with Quassia extract nematodes showed signs of altered morphology in their digestive system observed as empty spaces or bubbles (indicated by arrows). Normal nematodes do not display such altered morphology, indicating that Quassia extract treated Meloidogyne likely stopped feeding even if not completely dead.

In general, Quassia amara extract demonstrated insecticidal effect in most of the target pests, making it suitable to use in an integrated pest management scheme. In particular, Quassia amara extract may be particularly useful in combatting Frankliniella occidentalis, Tialeurodes vaporariorum, Tetranychus urticae for which Quassia amara insecticidal activity has not been previously reported. Quassia amara extract also demonstrated strong nematocidal activity against Meloidogyne sp.

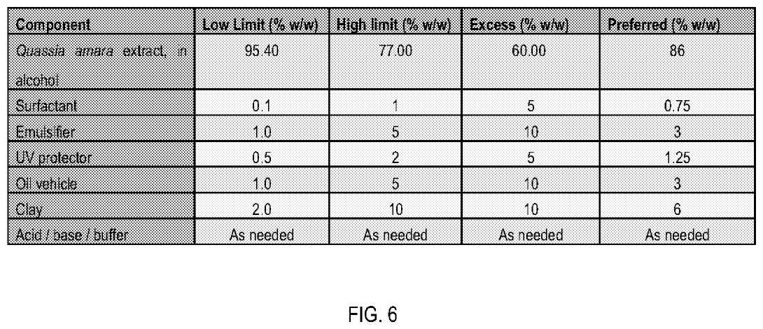

Controlled laboratory conditions make relatively easy for an active compound with slow effect to show efficacy, but in the field, temperature, light, and humidity can affect the activity, making it necessary to develop a more complex and robust formulation. Agricultural formulations are designed to protect the active ingredient against environmental factors, allow tank mixtures with other agrochemicals, facilitate insect cuticle penetration, and allow for a suitable drop size. Proposed Quassia amara insecticidal compositions for agricultural application are shown in FIG. 6.

Referring to FIG. 6, the “low limit,” “high limit,” and “preferred” columns refer to the minimum, maximum and preferred amounts, respectively, for surfactant, emulsifier, UV protector, oil vehicle and clay in the composition, according to various embodiments. The “excess” column lists excess amounts of surfactant, emulsifier, UV protector, oil vehicle and clay that may be used in some exceptional cases. It should be noted that all compositions shown in FIG. 6 are “concentrated” and must be further diluted in water prior to use. Preferably, the final amount of the Quassia extract applied to crops is ~1200 mg/hectare in a volume of water according to the crop's water requirement.

The Quassia amara extract containing quassin and neo-quassin is first dissolved in one of methanol, ethanol or isopropanol before combining with the other components. The surfactant, emulsifier and oil are provided to ensure proper mixing of the various components resulting in a shelf-stable emulsion that can be stored for later use.

The surfactant may be any one of Tween 20, Triton X0-100, Span 80 and Pluronic F-127. The emulsifier may be any one of polysorbate 80, lecithin, Span 80 and sodium lauryl sulphate.

The UV protector guards against degradation of the active compounds (quassin and neo-quassin) by ultraviolet radiation. The UV protector may be any one of benxophenone-4, ethylhexyl methoxyxinnamate, octocrylene and titanium dioxide.

The oil vehicle may be any one of soybean oil, sunflower oil and canola oil. The clay further protects against UV degradation and also achieves a formulation with less decantation in storage. The clay may be any one of attapulgite, kaolin, bentonite, and montmorillonite.

The composition may include an acid, base, or buffer, as needed, for adjusting the pH of the formulation between 3 and 7, and more preferably between 5.5 and 6.5. The acid/base/buffer may be citric acid, potassium phosphate, sodium bicarbonate, Tris-HCl, or phosphate buffered saline (PBS).

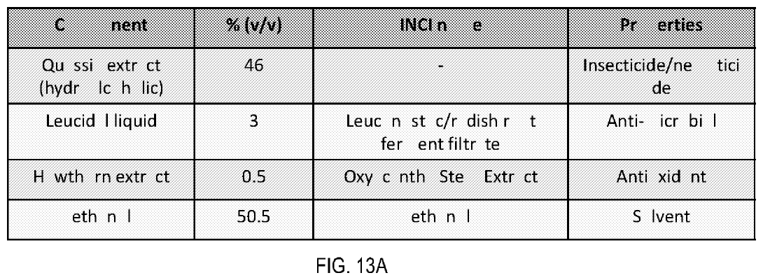

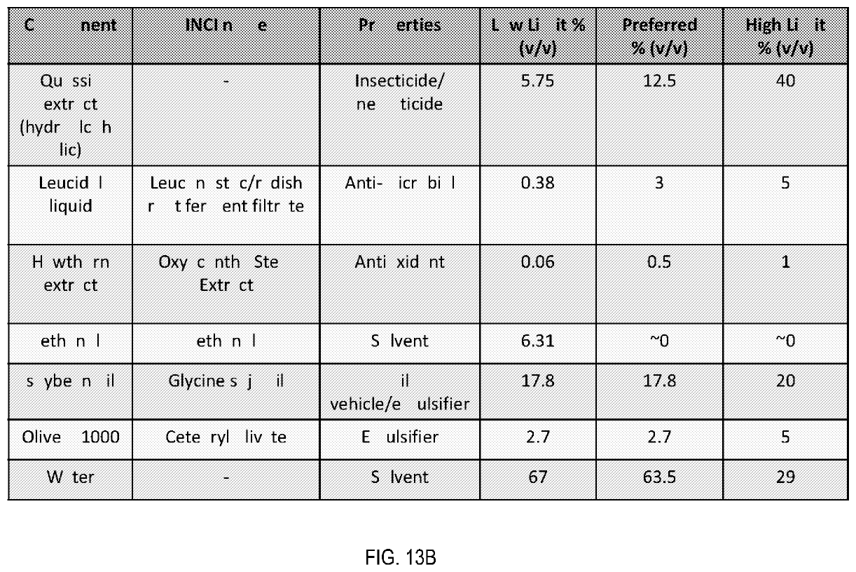

A nematicide formulation of Quassia extract is shown in FIG. 13A. The formulation further includes anti-microbial Leucidal liquid, hawthorn extract as an antioxidant, and ethanol as a solvent. It should be noted that the formulation shown in FIG. 13A is “concentrated” and must be further diluted in water prior to use. Generally, 0.5-5 mL, and preferably 0.5-2.5 mL, of the concentrated formulation is diluted in a volume of water prior to application to crops such that the final amount of the Quassia extract applied to crops is ~1200 mg/hectare.

It may be preferrable to provide an emulsifiable concentrate of the formulation in FIG. 13A, that is, a concentrate with the alcohol solvent substantially evaporated and replaced with water.

Referring to FIG. 13B, shown therein are emulsifiable nematicide Quassia extract compositions, according to several embodiments. The “low limit,” “high limit,” and “preferred” columns refer to the minimum, maximum and preferred amounts, respectively, for Quassia extract in the composition. The emulsifiable composition includes the Quassia extract, Leicidal liquid, Hawthorn extract, an oil vehicle (e.g., soybean oil), an emulsifier (e.g., Olivem 1000) and water as the solvent. Some ethanol may remain. The emulsified composition is a concentrated formulation that is mixed to form an emulsion and further diluted in water before application to crops such that the final amount of the Quassia extract that is applied to the crops is ~1200 mg/hectare.

### Piper Tuberculatum Biofungicide Activity.

The in-vitro antifungal activity of an ethanolic leaf extract of P. tuberculatum at a concentration of 100 mg/mL against Fusarium sp and Rhizoctonia sp was evaluated in MGI assays. The assays were conducted by mixing fungal growth media with the P. tuberculatum extract and measuring the inhibition of the fungal growth.

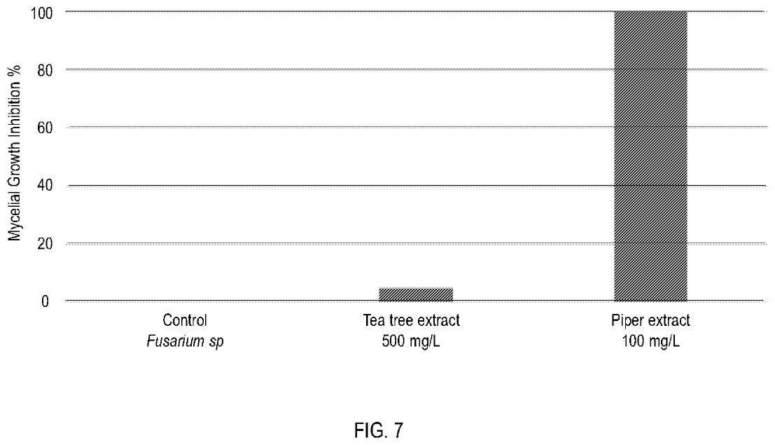

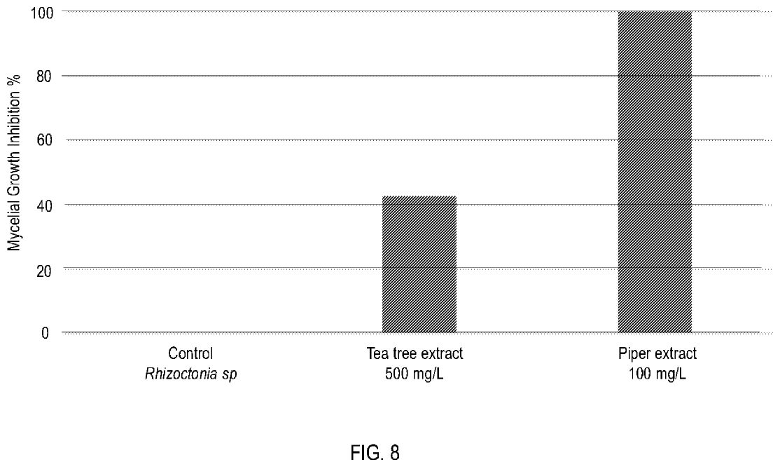

Referring to FIGS. 7 and 8, shown therein are the results of the MGI assays assessing P. tuberculatum extract fungicidal activity against Fusarium sp (FIG. 7) and Rhizoctonia sp (FIG. 8), according to several embodiments. Raw P. tuberculatum extract at 100 mg/mL demonstrated potent fungicidal activity resulting in 100% MGI for both phytopathogenic fungi, which has not been previously reported.

For developing a P. tuberculatum extract suitable for agricultural applications, it may be beneficial to include polymers such as chitosan or salicylic acid. The activation of the defence mechanism of plants against pathogens can be achieved using polymers like chitosan or salicylic acid. For example, an ethanol extract obtained from plants treated with chitosan improved the antifungal activity against Fusarium oxysporum F. sp vanilla showed 100% control compared to plant extracts without chitosan which show 41% of inhibition (Fernadez, M. D. et al, 2021).

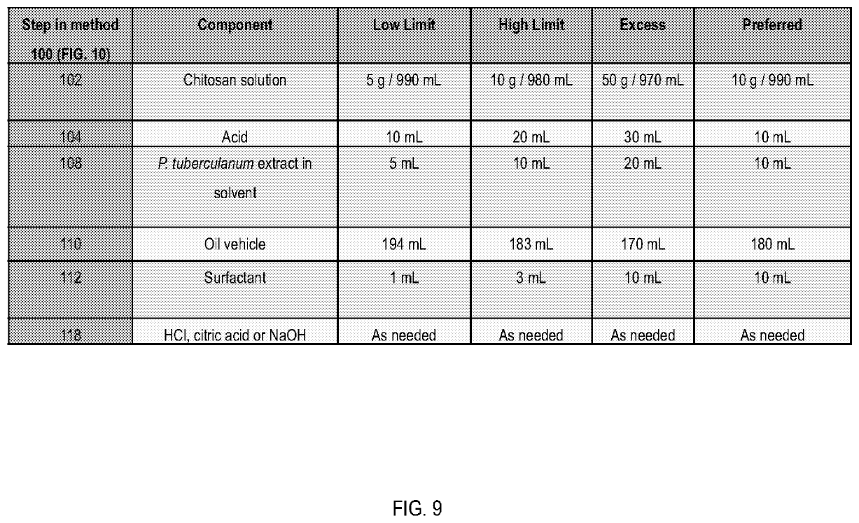

Referring to FIG. 9, showing therein is a chart of proposed fungicidal formulations containing P. tuberculatum and chitosan, according to several embodiments. The formulations are key to potentializing secondary metabolites in P. tuberculatum extract, and improving the solubility, stability and efficiency in the final product composition. The formulations shown in FIG. 9 may improve the control of the mycelial growth of fungi and the production of mycotoxins both in crop and storage grains. For example, antioxidants in Piper tuberculatum extract are useful in conservation and control of pathogens which is a desirable property for protecting seeds.

The “low limit,” “high limit,” and “preferred” columns refer to the minimum, maximum and preferred amounts, respectively, for chitosan, P. tuberculatum extract, acid and surfactant in the composition. The “excess” column lists excess amounts of chitosan, P. tuberculatum extract, acid and surfactant that may be used in some exceptional cases. It should be noted that all formulations shown in FIG. 9 are “concentrated” and must be further diluted in water prior to use. Generally, 0.5-5 mL, and preferably 0.5-2.5 mL, of the concentrated formulation is diluted in 1 L of water.

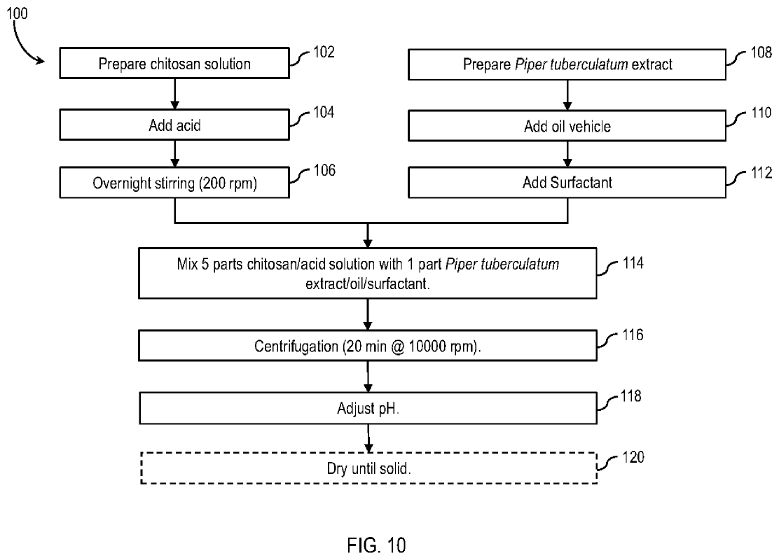

Referring to FIG. 10, shown therein is a flow chart of a method 100 for preparing a fungicidal composition, according to an embodiment. The method 100 may be implemented to prepare the fungicidal compositions shown in FIG. 9.

At 102, a chitosan solution is prepared by dissolving one or more of carboxymethyl chitosan, high-density chitosan, and chitosan acetate in water. The chitin solution includes chitin in an amount shown in FIG. 9, preferably 10 g in 990 mL solvent.

At 104, an acid is added to the chitosan solution in an amount shown in FIG. 9, preferably 10 mL, to aid in dissolving the chitosan. The acid may be acetic acid, lactic acid, or citric acid.

At 106, the chitosan solution is stirred overnight i.e., for at least 12 hours at 200 rpm to homogenize the mixture.

At 108, a P. tuberculatum extract is prepared by grinding 500 g of dried P. tuberculatum leaves, with a food processor in 2.5 L of ethanol, for 36 hours and then filtering the slurry with No 1. Wattman paper. After filtering, the liquid phase of the extract contains active compounds including piperine, piperlonguminine, fagaramide, I-piplartine and pellitorine (Cardenas-Laverde, D., et al.; Cotinguiba, F., et al.; Xu, W. H & Li, X. C.).

At 110, an oil vehicle is combined the extract in an amount shown in FIG. 9, to form an emulsion. The oil vehicle may be soybean oil, rapeseed oil or canola oil.

At 112, a surfactant is added to the emulsion in an amount shown in FIG. 9. The surfactant may be Tween 20, Triton X-100, or unscented dishwashing liquid.

At 114, the chitosan/acid solution and the P. tuberculatum extract/oil/surfactant emulsion are combined at a ratio of 5:1 to form a mixture. For example, 1000 mL of the chitosan solution is mixed with 200 ml of the tuberculatum extract/oil/surfactant emulsion.

At 116, the mixture is centrifuged at 10000 rpm for 20 minutes at room temperature to homogenize the mixture.

At 118, the pH of the emulsion is adjusted to between 3 and 7 and more preferably between 5.5 and 6.5 by addition of hydrochloric acid, citric acid, or sodium chloride, as needed. At this stage, if a liquid preparation is desired, the method 100 ends and the mixture obtained at step 118 is stored for later use or diluted in water for immediate use.

According to embodiments where a solid preparation is desired, at 120, the emulsion is dried until solid by drying, preferably by spray drying at 170 °C.

Mentha piperita nematicide activity. Biological activity of Mentha piperita extract was tested against juveniles of the phytopathogenic nematode Meloidogyne sp. A pure Mentha piperita oil extract obtained by steam distillation (purchased from simplynature.co) was used. Two dilutions of the pure Mentha extract were prepared for testing.

First 4 g of Arabic gum was diluted in 200 mL of water under magnetic stirring to form a homogenized 2% gum solution. 920 μL of gum solution was diluted in 99 mL water and 80 μL and 40 μL of the pure Mentha extract were added create the two dilutions, having a final concentration of 800 μL/L and 400 μL/L of Mentha extract, respectively. A control sample containing water in place of the Mentha extract was also prepared. The 800 μL/L and 400 μL/L concentrations of the Mentha extract and the control sample (water) were incubated with Meloidogyne sp and mortality was observed at 10, 24 and 48 hours after application of the Mentha extract. Dead and living nematodes were quantified; those that seemed immobile were stimulated with a fine brush and those that did not move after the stimulus were considered dead.

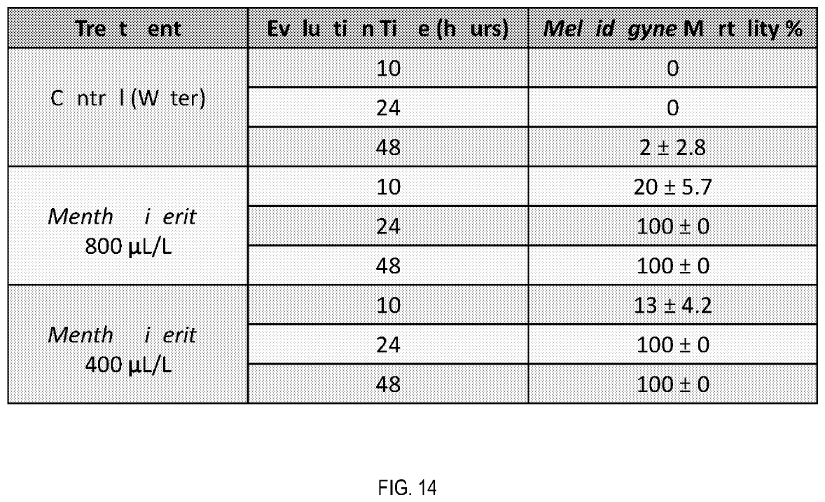

Referring to FIG. 14, Mentha extract exhibits Meloidogyne nematocidal activity with 100% mortality observed after 24 hours. The rate of mortality observed for Mentha extract is even higher than the mortality rate observed for Quassia extract (FIG. 11). Accordingly, a mixture of Quassia amara and Mentha piperita extracts was tested for nematicide activity against Meloidogyne.

A Quassia amara solution (1) was prepared by diluting 2.6 μL Quassia amara extract (obtained as described above) in 97.4 mL water. A Mentha piperita solution (2) was prepared by diluting 10 μL Mentha piperita extract (obtained as described above) in 990 μL of 2% Arabic gum solution and 99 mL water. The final Quassia/Mentha mixture was made by mixing 50 mL of each of solutions (1) and (2). Two controls were also prepared: an ethanol control by diluting 2.6 mL ethanol in 50 ml of 2% Arabic gum solution; and a water control by diluting 2.6 mL ethanol in 47.4 mL water. The mixture and controls were applied to 100 juvenile Meloidogyne individuals in three treatments and mortality was observed at 24-, 48-, and 72-hours post-application. Non-mobile individuals were stimulated with a fine brush to confirm death.

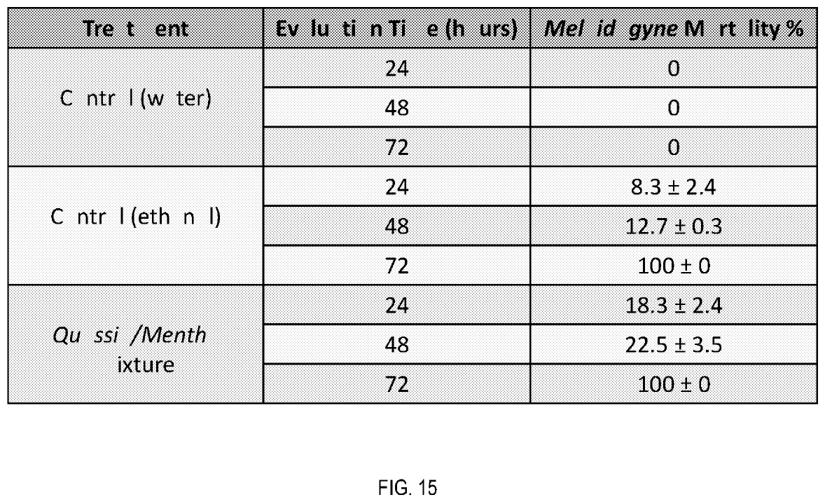

Referring to FIG. 15, no Meloidogyne mortality was observed for the water control. For the ethanol control, living nematodes at 24 and 48 hours showed slow movement and no movement was observed after 72 hours indicating 100% mortality. For the Quassia/Mentha mixture at 24 hours, living individuals had extremely low body movement; at 48 hours only mobility after stimulation with a brush was observed. At 72 hours, no movement was observed. Some individuals showed bubbles in their bodies, a clear indication of altered morphology indicating Meloidogyne likely stopped feeding even if not completely dead.

Based on the results in FIGS. 11, 14 and 15, it can be soundly predicted that a composition containing both Quassia and Metha extracts will have potent insecticidal and nematocidal effects against one of more of Frankliniella occidentalis, Tialeurodes vaporariorum, Tetranychus urticae, and Meloidogyne. Quassia extract alone at 23.3 mg/L (FIG. 11) resulted in 100% Meloidogyne mortality at 48 hours. Combining 0.013 μL/mL Quassia extract with Metha extract resulted in 100% Meloidogyne mortality at 72 hours (FIG. 15). This suggests, the dosage of Quassia extract can be reduced when combined with Metha extract to achieve comparable results to using a higher amount of Quassia extract alone.

It can be further soundly predicted that emulsifiable compositions containing a mixture of Quassia amara and Metha piperita extracts can be diluted in water and applied to crops as a combined insecticide and nematicide against one or more of Frankliniella occidentalis, Tialeurodes vaporariorum, Tetranychus urticae, and Meloidogyne.

While the above description provides examples of one or more formulations, compositions and methods, it will be appreciated that other formulations, compositions or methods may be within the scope of the claims as interpreted by one of skill in the art.

1. An insecticidal composition, comprising:
a Quassia amara extract in 60-95.4% w/w;
a surfactant in 0.1-5% w/w;
an emulsifier in 1-10% w/w;
a UV protector in 0.5-5% w/w;
an oil vehicle in 1-10% w/w; and
clay in 2-10% w/w.

2. The insecticidal composition of claim 1, further comprising a buffer for maintaining the composition at a pH between 3-7.

3. The insecticidal composition of any one of claims 1-2, wherein the Quassia amara extract comprises quassin and neoquassin.

4. The insecticidal composition of any one of claims 1-3, wherein the Quassia amara extract is extracted in one of: ethanol, methanol, and isopropanol.

5. The insecticidal composition of any one of claims 1-4, wherein the surfactant is one of: Tween 20, Triton X0-100, Span 80 and Pluronic F-127.

6. The insecticidal composition of any one of claims 1-5, wherein the emulsifier is one of: polysorbate 80, lecithin, Span 80 and sodium lauryl sulfate.

7. The insecticidal composition of any one of claims 1-6, wherein the UV protector is one of: benxophenone-4, ethylhexyl methoxyxinnamate, octocrylene and titanium dioxide.

8. The insecticidal composition of any one of claims 1-7, wherein the oil vehicle is one of: soybean oil, sunflower oil and canola oil.

9. The insecticidal composition of any one of claims 1-8, wherein the clay is one of: attapulgite, kaolin, bentonite, and montmorillonite.

10. The composition of any one of claims 1-9, diluted in water and applied to crops such that an amount of the Quassia amara extract applied to the crops is ~1200 mg/hectare.

11. Use of the composition of any one of claims 1-10 as an insecticide against one or more of: Frankliniella occidentalis, Trialeurodes vaporariorum and Tetranychus urticae.

12. A combined insecticidal and nematocidal composition, comprising:
a Quassia amara extract in 12.5-40% v/V;
Leucidal liquid in 3-5% v/v;
Hawthorn extract in 0.5-1% v/v;
an oil vehicle in 17.8-20% v/v;
an emulsifier in 2.7-5% v/v; and
water in 29-63.5% v/v.

13. The combined insecticidal and nematocidal composition of claim 12, comprising:
the Quassia amara extract in ~12.5% v/v;
the Leucidal liquid in ~3% v/v;
the Hawthorn extract in ~0.5% v/v;
the oil vehicle in ~17.8% v/v;
the emulsifier in ~2.7% v/v; and
water in ~63.5% v/v.

14. The combined insecticidal and nematocidal composition of any one of claims 12-12, wherein the Quassia amara extract comprises quassin and neoquassin.

15. The combined insecticidal and nematocidal composition of any one of claims 12-13, wherein the Quassia amara extract is extracted in one of: ethanol, methanol, and isopropanol.

16. The combined insecticidal and nematocidal composition of any one of claims 12-12 wherein, the oil vehicle is soybean oil.

17. The combined insecticidal and nematocidal composition of any one of claims 12-12, wherein the emulsifier is Olivem 1000.

18. The combined insecticidal and nematocidal composition of any one of claims 12-14, diluted in a volume of water and applied to crops such that an amount of the Quassia amara extract applied to the crops is ~1200 mg/hectare.

19. Use of the composition of any one of claims 12-18 as a combined insecticidal and nematocidal against Meloidogyne and one or more of: Frankliniella occidentalis, Trialeurodes vaporariorum and Tetranychus urticae.
